(19) United States
(12) Patent Application Publication
(10) Pub. No.: US 2025/0245952 A1
(43) Pub. Date: Jul. 31, 2025

(54) CONVOLUTION OPERATION CIRCUIT AND RELATED CONVOLUTION OPERATION METHOD

(71) Applicant: Realtek Semiconductor Corp., HsinChu (TW)

(72) Inventors: Chien-Hao Chen, HsinChu (TW); Chih-Yuan Koh, HsinChu (TW); Shih-Tse Chen, HsinChu (TW)

(73) Assignee: Realtek Semiconductor Corp., HsinChu (TW)

(21) Appl. No.: 18/922,330

(22) Filed: Oct. 21, 2024

(30) Foreign Application Priority Data
Jan. 29, 2024 (TW) 113103275

(51) Int. Cl. G06V 10/24; G06V 10/36; G06V 10/77; G06V 10/82

(52) U.S. Cl. CPC G06V 10/242; G06V 10/36; G06V 10/7715; G06V 10/82; G06V 2201/10

(57) ABSTRACT

A convolution operation circuit includes: a rotation determination unit, a convolution kernel adjustment unit and a convolution operation unit. The rotation determination unit is configured to determine a rotation state of input data. The convolution kernel adjustment unit is coupled to the rotation determination unit and configured to selectively adjust an initial convolution kernel according to the rotation state, thereby obtaining an adjusted convolution kernel. The convolution operation unit is coupled to the convolution kernel adjustment unit and configured to perform a convolution operation based on the adjusted convolution kernel and the input data to obtain a feature map.

### BACKGROUND OF THE INVENTION

### 1. Field of the Invention

The present invention relates to deep learning, and more particularly, to a convolution operation circuit and a related convolution operation method that can be applied to convolution-related layers of deep learning models.

### 2. Description of the Prior Art

Nowadays, deep learning technology has been widely used in various fields, such as image recognition, speech processing, natural language processing, etc. Deep learning models are typically composed of multi-layer neural networks that can learn complex features and patterns from large amounts of data. Among these technologies, convolutional neural network (CNN) performs particularly well in the field of image recognition due to its excellent image processing capabilities. When performing image recognition tasks, convolutional neural networks effectively extract image features through convolution operations, and these image features are subsequently used for classification and other higher-order processing. However, in actual scenarios, a placement angle of an image capture device may cause an image to rotate, which may further affect the recognition accuracy of the convolutional neural network model. This is because convolutional neural network models are usually trained based on the images with fixed orientations and are not robust enough for rotated images. In the existing technology, there are usually two approaches to solve this problem. One approach is to expand training data sets. By adding images having different rotation angles to the training data sets, the model's ability to recognize rotated images can be enhanced. However, although such method can improve the generalization ability of the model, it may cause the model to become larger and increase the cost of computational resources during training and inference. The other approach is image preprocessing. Before the image is inputted into the model, the preprocessing of image rotation correction (normalizing the image) is performed. This can be achieved through image processing techniques such as affine transformation. However, image preprocessing also requires additional computational resources to execute, or even setting up additional dedicated circuits, which will result in additional computational resource costs or hardware costs. In view of above, the conventional convolutional neural network model or deep learning model still has shortcomings in the applications of image recognition.

### SUMMARY OF THE INVENTION

In view of this, it is one object of the present invention to provide a convolution operation circuit and related method, which can improve the adaptability of deep learning models or convolutional neural network models to different direction/rotation of input images. In the embodiments of the present invention, a convolution kernel is selectively adjusted according to a rotation state of an input image. When the input image has a non-zero rotation angle, the convolution operation on the input image will be performed by using an adjusted convolution kernel. The advantage of the present invention is that it does not need to occupy additional computational resources or increase additional hardware costs to perform image preprocessing, nor does it need to train the model for images with non-zero rotation angles, resulting in an increase in model sizes.

According to one embodiment, a convolution operation circuit is provided. The convolution operation circuit comprises: a rotation determination unit, a convolution kernel adjustment unit and a convolution operation unit. The rotation determination unit is configured to determine a rotation state of input data. The convolution kernel adjustment unit is coupled to the rotation determination unit, and configured to selectively adjust an initial convolution kernel according to the rotation state, thereby obtaining an adjusted convolution kernel. The convolution operation unit is coupled to the convolution kernel adjustment unit, and configured to perform a convolution operation based on the adjusted convolution kernel and the input data to obtain a feature map.

According to one embodiment, a convolution operation method is provided. The convolution operation method comprises: determining a rotation state of input data; selectively adjusting an initial convolution kernel according to the rotation state, thereby obtaining an adjusted convolution kernel; and performing a convolution operation based on the adjusted convolution kernel and the input data to obtain a feature map.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a convolution operation circuit according to one embodiment of the present invention.

FIG. 2A and FIG. 2B illustrate changes of input data in response to rotation of an aligned image and a non-aligned image.

FIG. 3A and FIG. 3B illustrate how to use an initial convolution kernel and an adjusted convolution kernel to perform convolution operation on input data of an aligned image and a non-aligned image according to embodiments of the present invention.

FIG. 4A and FIG. 4B illustrate how to use an initial convolution kernel and an adjusted convolution kernel to perform convolution operation on padded input data of an aligned image and a non-aligned image according to embodiments of the present invention.

FIG. 5 illustrates a flow chart of a convolution operation method according to one embodiment of the present invention.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment” or “an embodiment” means that a particular feature, structure or characteristic described in connection with the embodiment or example is included in at least one embodiment of the present embodiments. Thus, appearances of the phrases “in one embodiment” or “in an embodiment” in various places throughout this specification are not necessarily all referring embodiment. Furthermore, the particular features, structures or characteristics may be combined in any suitable combinations and/or sub-combinations in one or more embodiments.

The present invention proposes a convolution operation circuit and method that can be applied to convolution layers or layers related to convolution operation of deep learning models or convolutional neural network models. The present invention has decent adaptability to input data and can effectively improve the efficiency of convolution operations on non-aligned images, thereby to more effectively extract features from input data for use in subsequent layers (e.g., pooling layer and fully connected layer) of deep learning models or convolutional neural network models to perform classification, detection or other advanced tasks.

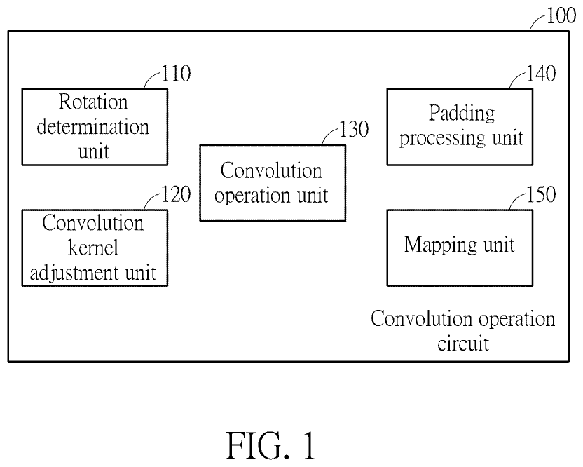

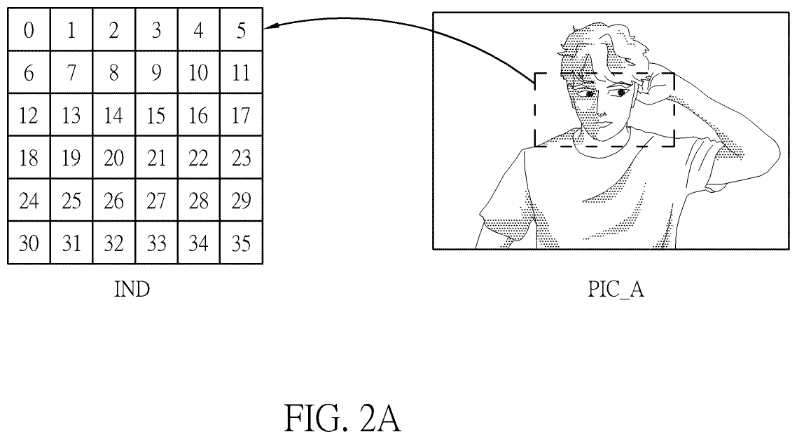

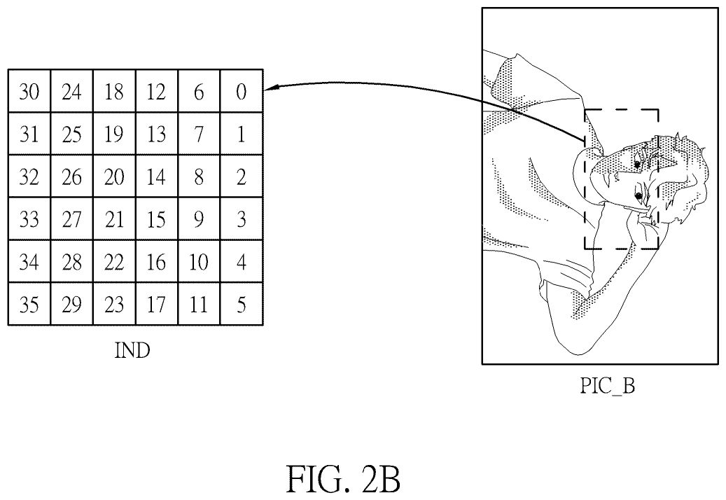

Please refer to FIG. 1, which illustrates a schematic diagram of a convolution operation circuit according to one embodiment of the present invention. As shown in the figure, the convolution operation circuit 100 includes: a rotation determination unit 110, a convolution kernel (also referred to as convolution filter) adjustment unit 120, a convolution operation unit 130 and a padding processing unit 140. The rotation determination unit 110 is configured to determine a rotation state R_INFO of input data IND. Please refer further to embodiments of FIG. 2A and FIG. 2B. A captured image PIC_A of FIG. 2A can be a still image or one image frame of an image sequence produced by an image capturing device (such as a still camera or a video camera) shooting a scene, and the input data IND can be pixel data corresponding to one of blocks of the captured image PIC_A. Under different shooting conditions, the image capturing device may be rotated, thereby generating a captured image PIC_B that is rotated 90 degrees clockwise relative to the captured image PIC_A. Specifically, in embodiments of the present invention, the input data IND can be one of pixel data corresponding to an image block of the captured image PIC_A, pixel data corresponding to an image block of a captured image PIC_B that is rotated 90 degrees clockwise relative to the captured image PIC_A or and pixel data corresponding to an image block of a non-aligned captured image with a specific rotation angle relative to the captured image PIC_A. The rotation state R_INFO generated by the rotation determination unit 110 indicates a rotation angle between an aligned captured image (for example, a captured image whose subject is aligned with the top of the captured image) and a captured image to which the input data IND belongs. Furthermore, in different embodiments of the present invention, the rotation determination unit 110 can determine and generate the rotation state R_INFO based on metadata of the captured image, device rotation information generated by the image capture device, or features of specific elements in the captured image.

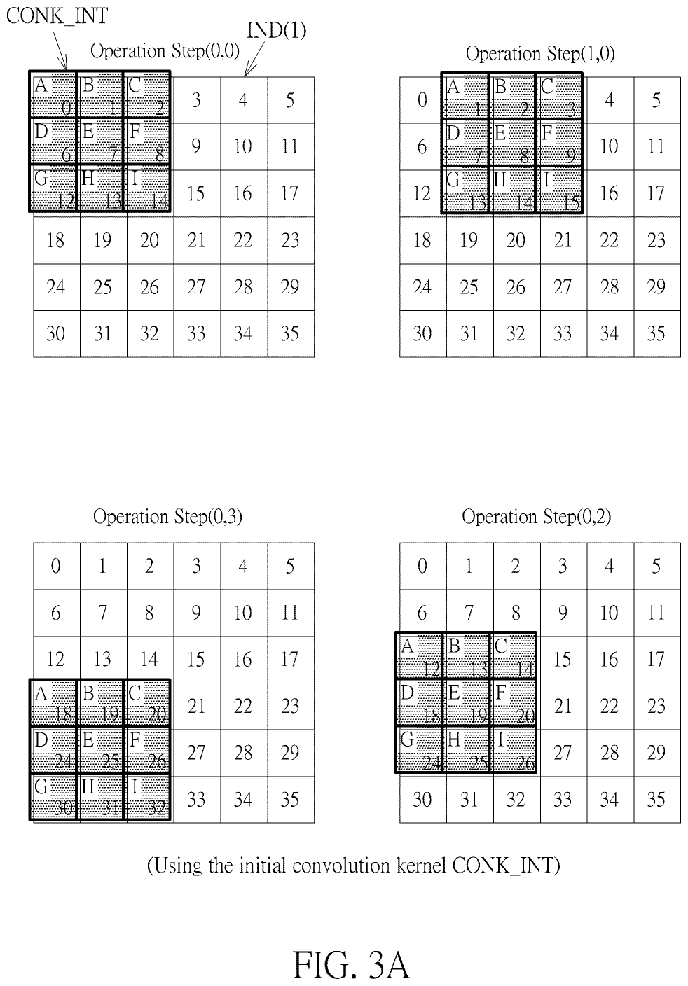

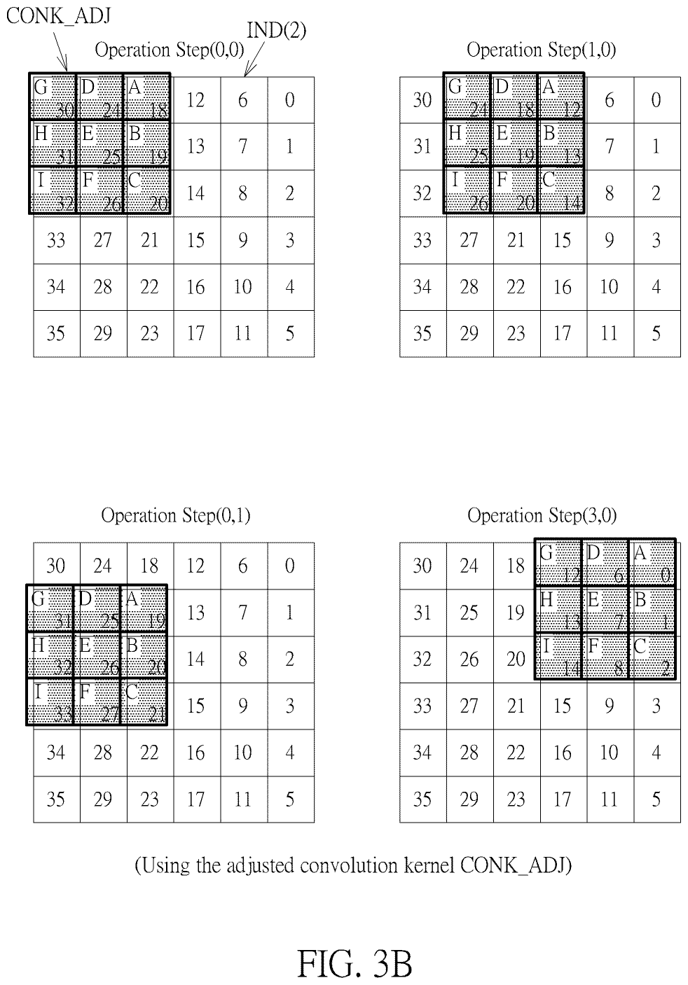

Furthermore, the convolution kernel adjustment unit 120 is configured to adjust an initial convolution kernel CONK_INT according to the rotation state R_INFO, thereby obtaining an adjusted convolution kernel CONK_ADJ. Please further refer to principles of convolution operation shown by FIG. 3A and FIG. 3B. In FIG. 3A, input data IND(1) represents pixel data (including pixel data 0-35) of an image block of an aligned captured image. In view of this, the convolution operation on the input data IND(1) can be performed via the initial convolution kernel CONK_INT (including convolution weights A, B, C, D, E, F, G, H, I). On the other hand, in FIG. 3B, input data IND(2) is pixel data (including pixel data 0-35 that is rotated 90 degrees clockwise) of an image block of a non-aligned captured image that is rotated 90 degrees clockwise. Therefore, the convolution operation on the input data IND(2) needs to be performed via the adjusted convolution kernel CONK_ADJ (including the convolution weights A, B, C, D, E, F, G, H, I that are rotated 90 degrees clockwise). Since the rotation state R_INFO of the input data IND(2) is rotated 90 degrees clockwise, the convolution kernel adjustment unit 120 will rotate the convolution weights A-I of the initial convolution kernel CONK_INT 90 degrees clockwise to obtain the adjusted convolution kernel CONK_ADJ. Please note that, as the rotation state R_INFO of the input data IND may be different, the convolution kernel adjustment unit 120 may adaptively rotate the initial convolution kernel CONK_INT, instead of the above-mentioned clockwise rotation of 90 degrees. For example, if the rotation state R_INFO of the input data IND indicates 180 degrees clockwise rotation, the convolution kernel adjustment unit 120 will rotate the initial convolution kernel CONK_INT 180 degrees clockwise to obtain the adjusted convolution kernel CONK_ADJ.

The convolution operation unit 130 would rely on the adjusted convolution kernel CONK_ADJ and the input data IND to perform a convolution operation to obtain a convolution operation result. Please note that, if the rotation state R_INFO of the input data IND indicates that the input data IND is pixel data of an aligned captured image, the convolution operation unit 130 would utilize the initial convolution kernel CONK_INT to perform the convolution operation on the input data IND. Further, the convolution operation unit 130 would perform the following operations: placing the initial convolution kernel CONK_INT or the adjusted convolution kernel CONK_ADJ at the first column and the first row of the input data IND(1) or the input data IND(2), calculating a dot product of the initial convolution kernel CONK_INT (or the adjusted convolution kernel CONK_ADJ) with the data it covers (i.e., a sum of products of each pixel data and a corresponding convolution weight), generating an output value and then moving the initial convolution kernel CONK_INT (or the adjusted convolution kernel CONK_ADJ) to the right along the row direction by one stride unit. For example, move the initial convolution kernel CONK_INT (or the adjusted convolution kernel CONK_ADJ) by one unit to the right along the row direction (when the stride unit is 1) or move the initial convolution kernel CONK_INT (or the adjusted convolution kernel CONK_ADJ) by two units to the right along the row direction (when the stride unit is 2). Then, the dot product between the initial convolution kernel CONK_INT (or the adjusted convolution kernel CONK_ADJ) and the data it covers is calculated again to generate another output value. Once the initial convolution kernel CONK_INT or the adjusted convolution kernel CONK_ADJ is moved to the end along the row direction of the input data IND(1) or the end along the row direction of the input data IND(2), return to the beginning of the row direction and move down one step unit (e.g., after returning the first row and the first column along the row column direction, move down one unit along the column direction (when the stride unit is 1) or move down two units along the column direction (when the stride unit is 2)), and continue this process until the initial convolution kernel CONK_INT or the adjusted convolution kernel CONK_ADJ covers the entire input data IND(1) or the entire input data IND(2).

When the convolution operation unit 130 performs a convolution operation on the adjusted convolution kernel CONK_ADJ and the input data IND, the generated operation result may need to be processed by a mapping unit 150 of the convolution operation circuit 100. Only in this way the convolution operation result (i.e., a feature map) that is consistent with the aligned captured image can be obtained. Please refer again to FIG. 3A and FIG. 3B. Taking the embodiment in the figure as an example, when the adjusted convolution kernel CONK_ADJ that is rotated 90 degrees clockwise is utilized to perform a convolution operation on the input data IND(2) (as shown in FIG. 3B), a result of the operation step (0, 0) thereof is substantially consistent with a result of the operation step (0, 3) of an convolution operation based on the initial convolution kernel CONK_INT and the input data IND(1) (as shown in FIG. 3A). In addition, a result of the operation step (1, 0) of an convolution operation based on the adjusted convolution kernel CONK_ADJ and the input data IND(2) is substantially consistent with a result of the operation step (0, 2) of an convolution operation based on the initial convolution kernel CONK_INT and the input data IND(1). Therefore, in some embodiments, the mapping unit 150 can be utilized to process (map) the result of the convolution operation based on the adjusted convolution kernel CONK_ADJ, thereby obtaining the same feature map of the convolution operation based on initial convolution kernel CONK_INT.

However, it should be noted that the mapping unit 150 is not a necessary component. In some embodiments of the present invention, when the convolution operation unit 130 utilizes the adjusted convolution kernel CONK_ADJ to perform the convolution operation on the input data IND(2), it is possible to perform the convolution operation in a non-typical order, which does not follow the order from upper left to lower right. For example, the convolution operation unit 130 can directly start from the operation step (3, 0) as the first step of the convolution operation based on the adjusted convolution kernel CONK_ADJ and the input data IND(2) and since the result thereof is exactly the same as the result of the operation step (0, 0) of the convolution operation based on the initial convolution kernel CONK_INT and the input data IND(1). Then, the convolution operation unit 130 could move the adjusted convolution kernel CONK_ADJ downward by one stride unit and perform the operation step (3, 1). The result of the operation step (3, 1) of the convolution operation based on the adjusted convolution kernel CONK_ADJ and the input data IND(2) is exactly the same as the result of the operation step (1, 0) of the convolution operation based on the initial convolution kernel CONK_INT and the input data IND(1). By analogy, through the above-mentioned non-typical order, results that are exactly the same as the results of the convolution operation based on the initial convolution kernel CONK_INT and the input data IND(1) can be obtained. Based on such non-typical order, the mapping unit 150 can be omitted.

In some cases, when there are specific requirements for the size of the feature map generated by the convolution operation, the convolution operation circuit 100 may perform padding processing on the input data IND. For example, if it is intended to obtain a feature map with the same size as the input data, it is necessary to perform padding processing on edges of the top row, the bottom row, the leftmost column, and the rightmost column of the input data IND, and accordingly perform the convolution operation with a stride of 1 unit. Moreover, if it is intended to obtain a feature map with half the size of the input data, it is necessary to perform padding processing one edges of the bottom row and the rightmost column of the input data IND, and accordingly perform the convolution operation with a stride of 2 units.

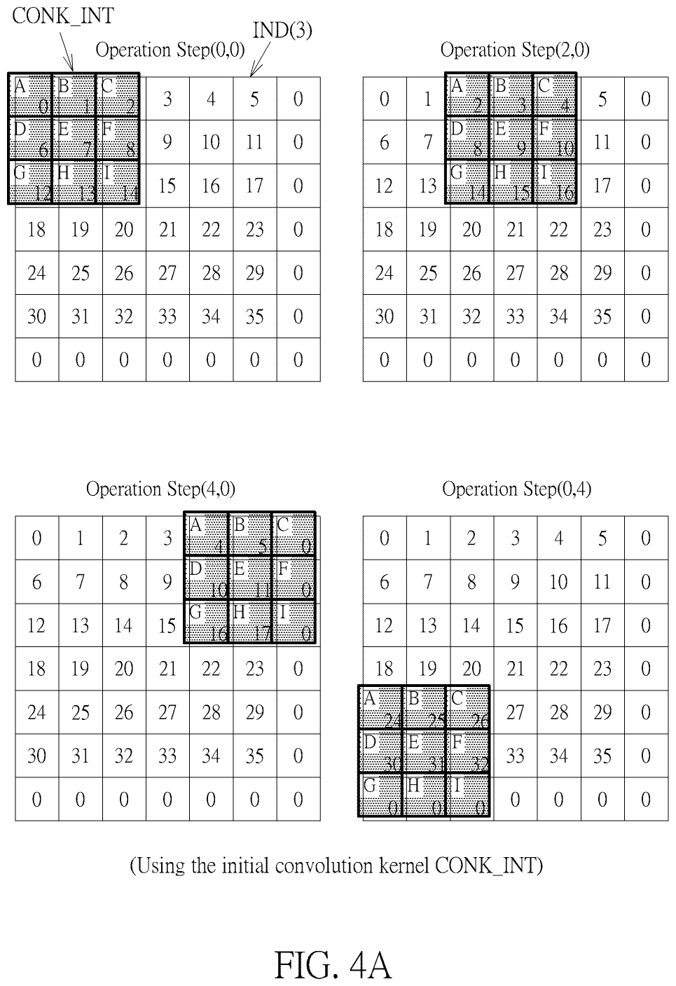

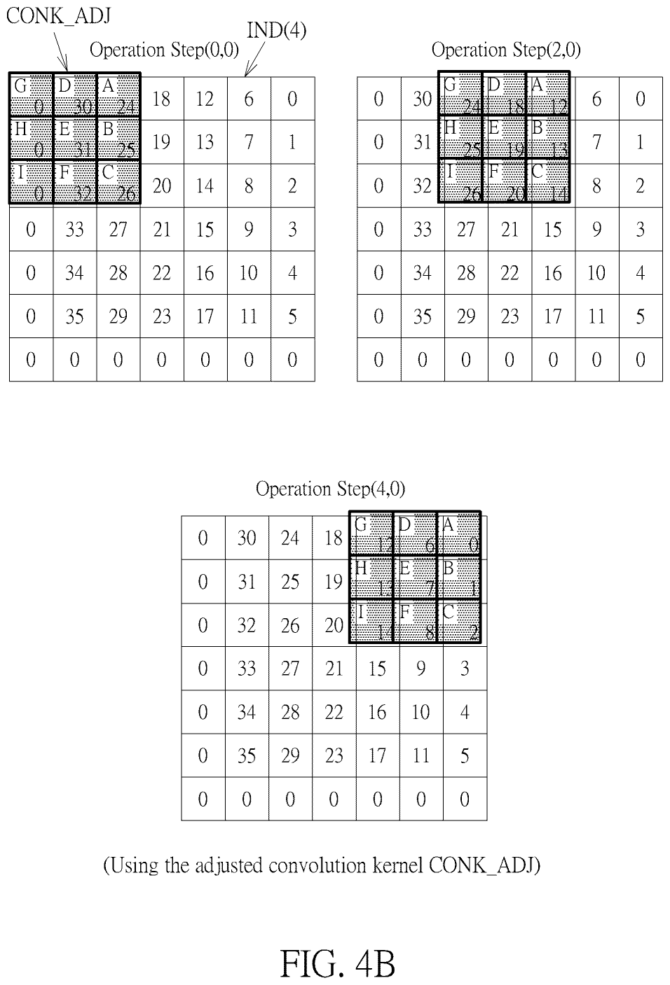

When the padding processing unit 140 of the convolution operation circuit 100 determines to perform a padding processing on the input data IND, the padding processing unit 140 would take the rotation state R_INFO of the input data IND into consideration. Please refer to FIG. 4A and FIG. 4B. As shown in the embodiment of FIG. 4A, when the padding processing unit 140 performs the padding processing on the input data IND(1) belonging to the aligned captured image, the padding processing unit 140 would add padding data (i.e., using data of “0” for padding (zero-padding)) next to the rightmost column of the input data IND(1), as well as add padding data below the bottom row of the input data IND(1), thereby to obtain the padded data IND(3). In the embodiment shown in FIG. 4B, as the input data IND(2) belongs to the non-aligned captured image, the padding processing unit 140 would perform the padding processing based on a padding principle different from that shown in FIG. 4A (i.e., adding padding data to the right and below the input data). Specifically, since the rotation state R_INFO of the input data IND(2) indicates a rotation angle of 90 degrees clockwise relative to the input data IND(1) that belongs to the aligned captured image, the padding processing unit 140 would not add the padding data to the right and below the input data IND(2). Instead, the padding processing unit 140 would add padding data (using data of “0” for padding) to the left of the leftmost column of the input data IND(2), and add padding data below the bottom row of the input data IND(2) to obtain padded data IND(4). Furthermore, as the rotation state R_INFO of the input data IND could vary, the padding processing unit 140 would add the padding data at different positions. By comparing FIG. 4A and FIG. 4B, it can be understood that after padding data based on the abovementioned principles, the convolution operation result of the non-aligned padded input data IND(4) and the adjusted convolution kernel CONK_ADJ can be consistent with convolution operation results of the aligned padded input data IND(3) and the initial convolution kernel CONK_INT.

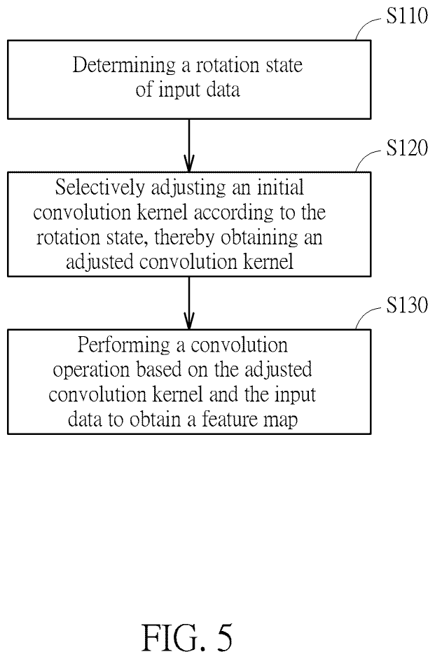

FIG. 5 illustrates a flow chart of a convolution operation method according to one embodiment. As illustrated, the method comprises the following simplified flow:
Step S110: determining a rotation state of input data;
Step S120: selectively adjusting an initial convolution kernel according to the rotation state, thereby obtaining an adjusted convolution kernel; and
Step S130: performing a convolution operation based on the adjusted convolution kernel and the input data to obtain a feature map.

Since principles and specific details of the above steps have been described in detail in previous embodiments, repeated descriptions will not be omitted here. It is worth mentioning that the above flow can be improved by adding other additional steps, or making appropriate modifications and adjustments, to better achieve the computational efficiency of the convolution-related layers, thereby further improving inference efficiency and performance of the deep learning model or convolutional neural network model.

It can be seen from the above embodiments that the convolution operation circuit and method of the present invention have good adaptability to input data of non-aligned (rotated) images. That is, the convolution operation circuit and method of the present invention do not need to rely on additional image preprocessing to perform rotation correction on the input data of the non-aligned (rotated) image (i.e., normalizing the input data of the non-aligned (rotated) image). Instead, it is possible to directly perform convolution operations on the input data of the non-aligned (rotated) image using the adjusted convolution kernel. In addition, the convolution operation circuit and method of the present invention do not need to expand the training data set to improve the model's adaptability to changes in the angle or rotation of images. In other words, the convolution operation circuit and method of the present invention are applicable to any model trained with aligned (un-rotated) images, and there is no need to retrain the model. Compared with the conventional art, the convolution operation circuit and method of the present invention have lower requirements for computational resources and hardware, and are more suitable for many types of edge devices.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A convolution operation circuit, comprising:
a rotation determination unit, configured to determine a rotation state of input data;
a convolution kernel adjustment unit, coupled to the rotation determination unit, configured to selectively adjust an initial convolution kernel according to the rotation state, thereby obtaining an adjusted convolution kernel; and
a convolution operation unit, coupled to the convolution kernel adjustment unit, configured to perform a convolution operation based on the adjusted convolution kernel and the input data to obtain a feature map.

2. The convolution operation circuit of claim 1, wherein the rotation determination unit is configured to determine the rotation state based on metadata of a captured image to which the input data corresponds, device rotation information of an image capture device which generates the captured image and/or a feature of specific elements in the captured image.

3. The convolution operation circuit of claim 1, wherein the convolution kernel adjustment unit is configured to rotate convolution weights in the initial convolution kernel with a rotation angle that is indicated by the rotation state, thereby obtaining the adjusted convolution kernel.

4. The convolution operation circuit of claim 1, further comprising:
a padding processing unit, configured to perform a padding processing on the input data according to the rotation state, thereby obtaining padded input data;
wherein a position of padding data in the padded input data is associated with the rotation state.

5. The convolution operation circuit of claim 4, wherein the convolution kernel adjustment unit is configured to perform the convolution operation based on the adjusted convolution kernel and the padded input data, thereby obtaining the feature map.

6. The convolution operation circuit of claim 1, further comprising:
a mapping unit, configured to perform, according to the rotation information, a mapping processing on a plurality of operation results that are generated by performing the convolution operation on the adjusted convolution kernel and the input data.

7. A convolution operation method, comprising:
determining a rotation state of input data;
selectively adjusting an initial convolution kernel according to the rotation state, thereby obtaining an adjusted convolution kernel; and
performing a convolution operation based on the adjusted convolution kernel and the input data to obtain a feature map.

8. The convolution operation method of claim 7, wherein the step of determining the rotation state comprises:
determining the rotation state based on metadata of a captured image to which the input data corresponds, device rotation information of an image capture device which generates the captured image and/or a feature of specific elements in the captured image.

9. The convolution operation method of claim 7, wherein the step of selectively adjusting an initial convolution kernel according to the rotation state comprises:
rotating convolution weights in the initial convolution kernel with a rotation angle that is indicated by the rotation state, thereby obtaining the adjusted convolution kernel.

10. The convolution operation method of claim 7, further comprising:
performing a padding processing on the input data according to the rotation state, thereby obtaining padded input data, wherein a position of padding data in the padded input data is associated with the rotation state.

11. The convolution operation method of claim 10, wherein the step of perform the convolution operation comprises:
performing the convolution operation based on the adjusted convolution kernel and the padded input data, thereby obtaining the feature map.

12. The convolution operation method of claim 7, further comprising:
performing, according to the rotation information, a mapping processing on a plurality of operation results that are generated by performing the convolution operation on the adjusted convolution kernel and the input data.
